(19) United States
(12) Patent Application Publication
(10) Pub. No.: US 2016/0204677 A1
(43) Pub. Date: Jul. 14, 2016

(54) MOTOR WITH HEAT DISSIPATION STRUCTURE

(71) Applicant: Wen-San CHOU, TAINAN (TW)

(72) Inventor: Wen-San CHOU, TAINAN (TW)

(21) Appl. No.: 14/983,564

(22) Filed: Dec. 30, 2015

(30) Foreign Application Priority Data
Jan. 8, 2015 (TW) 104100602

(51) Int. Cl. H02K 9/06; H02K 5/20; H02K 5/16

(52) U.S. Cl. CPC H02K 9/06; H02K 5/16; H02K 5/20

(57) ABSTRACT

A motor includes a substantially cylindrical housing, a rotor assembly, a cover, and a cooling fan. The cooling fan is installed at one end of a rotating shaft of the rotor assembly to induce airflow. The cover, which is mounted to the housing, is provided with a plurality of wind-caching projections, each of which is located above one upstream through hole defined on the housing and faces towards the cooling fan. The wind-catching projections can receive the airflow induced by the cooling fan and guides the airflow to enter the housing via the upstream through holes to dissipate the heat accumulated in the motor, so that the motor can be prevented from damages due to heat accumulation. Therefore, the performance and service life of the motor can be increased.

### TECHNICAL FIELD OF THE INVENTION

The present invention relates to a motor with a heat dissipation structure and, more particularly, to a motor which has a cover being provided with a plurality of wind-catching projections and has a cooling fan which can induce airflow to quickly enter the motor's housing via the wind-catching projections to dissipate the heat accumulated in the motor.

### DESCRIPTION OF THE PRIOR ART

Today, motors are widely used in industry for providing mechanical power. When a motor, irrespective of lower or high power, is running, the rotor assembly (including an armature core formed by an iron core wound with enameled wire, a commutator, a brush unit, etc.) and the magnets in the motor's housing will generate heat and thus cause a temperature rise. In particular, the heat accumulated in the motor's housing may cause the brush unit to contain more carbon deposits, thus affecting the electrical circuit of the motor. Besides, high temperature resulting from the armature core may reduce the magnetic intensity of the magnets used in the motor. Thus, the performance of the motor will be gradually reduced.

Currently, emergency repair kits, which are commonly used in daily life, employ a low-power motor to drive a compressor unit therein for repairing punctured tires. However, in some countries, the Traffic Act stipulates that, when a vehicle has a punctured tire on a highway, the driver should repair the punctured tire within a specified period and should immediately drive away after the repair is completed to prevent rearward bump. Under these circumstances, for completing the repair as soon as possible, the motor of the compressor unit of an emergency repair kit should be operated at a higher speed. However, if the heat accumulated in the motor's housing cannot be quickly taken away, the performance of the motor will decrease. Even worse, the enameled wire of the armature core will probably be damaged to cause a short circuit, and thus the motor may be burn out.

For solving this problem, a motor is usually installed with a cooling fan at its output shaft. However, the airflow induced by the cooling fan can only flow along the outer surface of the motor's housing. Thus, the heat generated by the armature core, especially the enameled wire, in the motor is not easy to be taken away. The problem of a motor being subject to heat accumulation has not yet been overcome.

### SUMMARY OF THE INVENTION

One object of the present invention is to provide a motor with a heat dissipation structure, which comprises a substantially cylindrical housing, a rotor assembly, a cover, and a cooling fan. The housing has a circumferential wall which terminates at a flat closure wall and opens out at an opening opposite to the flat closure wall, wherein the flat closure wall of the housing is provided with a first bearing at its center and defines a plurality of downstream through holes; the circumferential wall of the housing defines a plurality of upstream through holes. The rotor assembly is located in the housing. The cover is provided with a second bearing at its center and mounted to the housing for sealing the opening of the housing. The cooling fan is mounted at one end of a rotating shaft of the rotor assembly, near the cover. The cover is provided with a plurality of wind-catching projections around its circumference, wherein each wind-collecting projection is located above one of the upstream through holes of the housing. Each wind-catching projection is a bulging layer which has a roof and two slant walls joined between the roof and the circumference of the cover to define an air guiding channel therebetween facing towards the cooling fan and communicating with one of the upstream through holes of the housing, so that the airflow induced by the cooling fan can easily pass through the air guiding channels and the upstream through holes to enter the housing, and can go out of the housing via the downstream through holes to take away the heat generated in the motor, so that heat is not easy to accumulate in the motor, and thus the performance and service life of the motor can be increased.

Other objects, advantages, and novel features of the present invention will become more apparent from the following detailed description when taken in conjunction with the accompanying drawings.

### BRIEF DESCRIPTION OF THE DRAWINGS

FIG. 1 shows a 3-dimensional view of a motor according to one embodiment of the present invention.

FIG. 2 shows a 3-dimensional view of the motor, which is viewed from a different angle than FIG. 1.

FIG. 3 shows a partially exploded view of the motor.

FIG. 4 shows an exploded view of the motor.

FIG. 5 shows a 3-dimensional view of a cover used in the motor, wherein the cover is provided with a plurality of wind-catching projections.

FIG. 6 shows a plan view of the motor.

FIG. 7 shows a sectional view of the motor taken along line A-A in FIG. 6, wherein the airflow entering the motor' housing is demonstrated.

FIG. 8 shows a sectional view of the motor taken along line B-B in FIG. 6, wherein the airflow entering the motor's housing is demonstrated.

FIG. 9 shows a schematic view of the motor, wherein some of the airflow flows along the outer surface of the motor's housing by way of recesses is demonstrated.

### DETAILED DESCRIPTION OF THE PREFERRED EMBODIMENTS

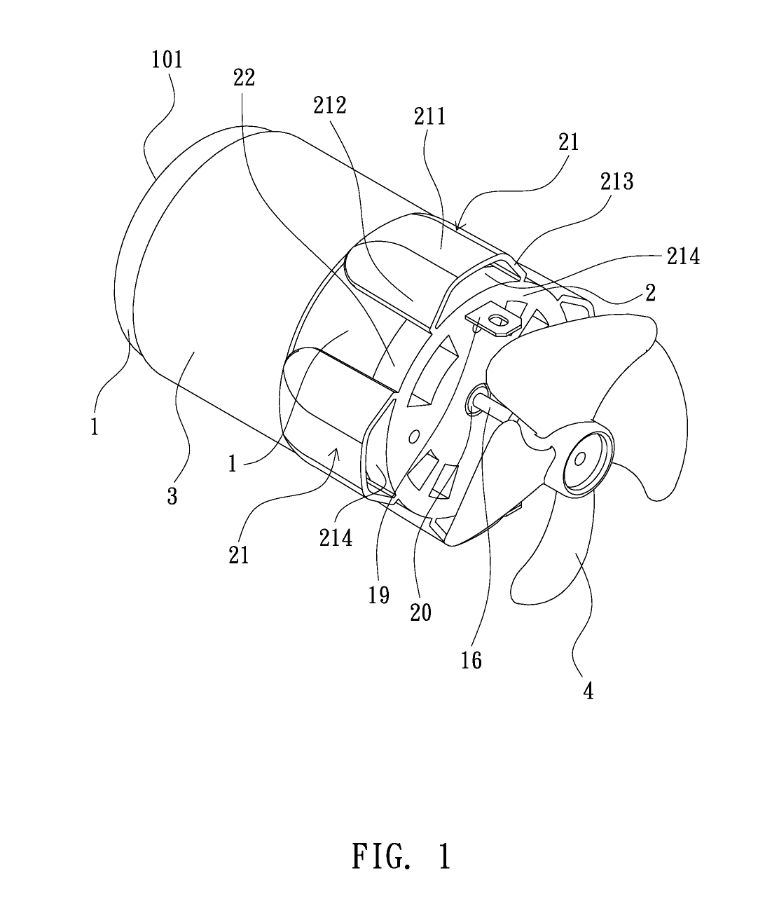

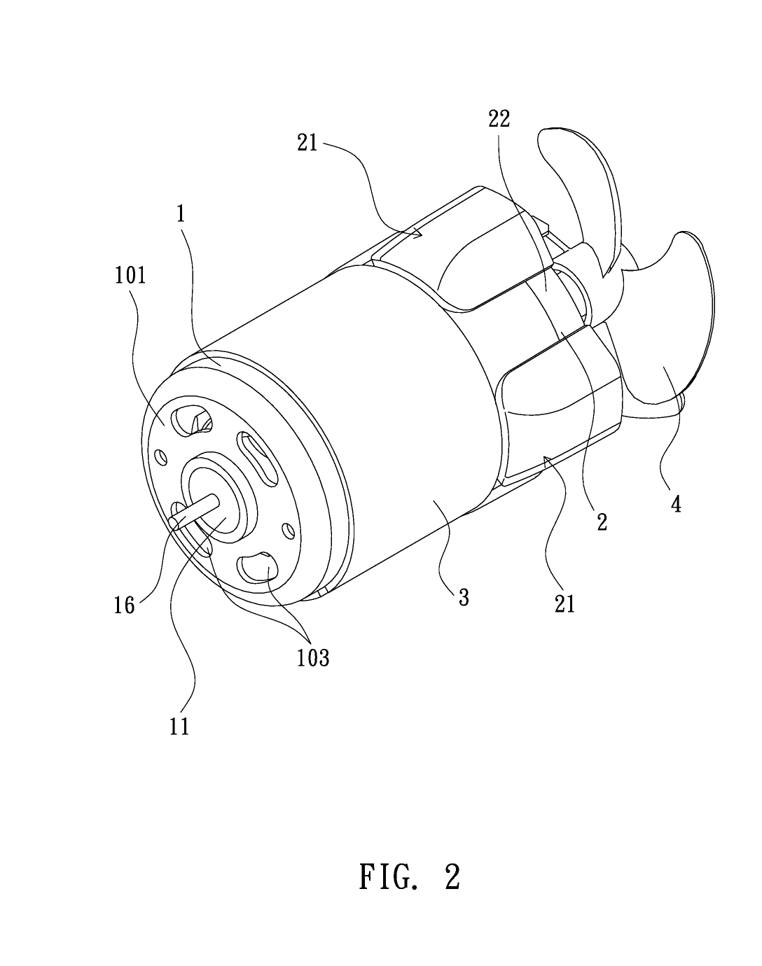

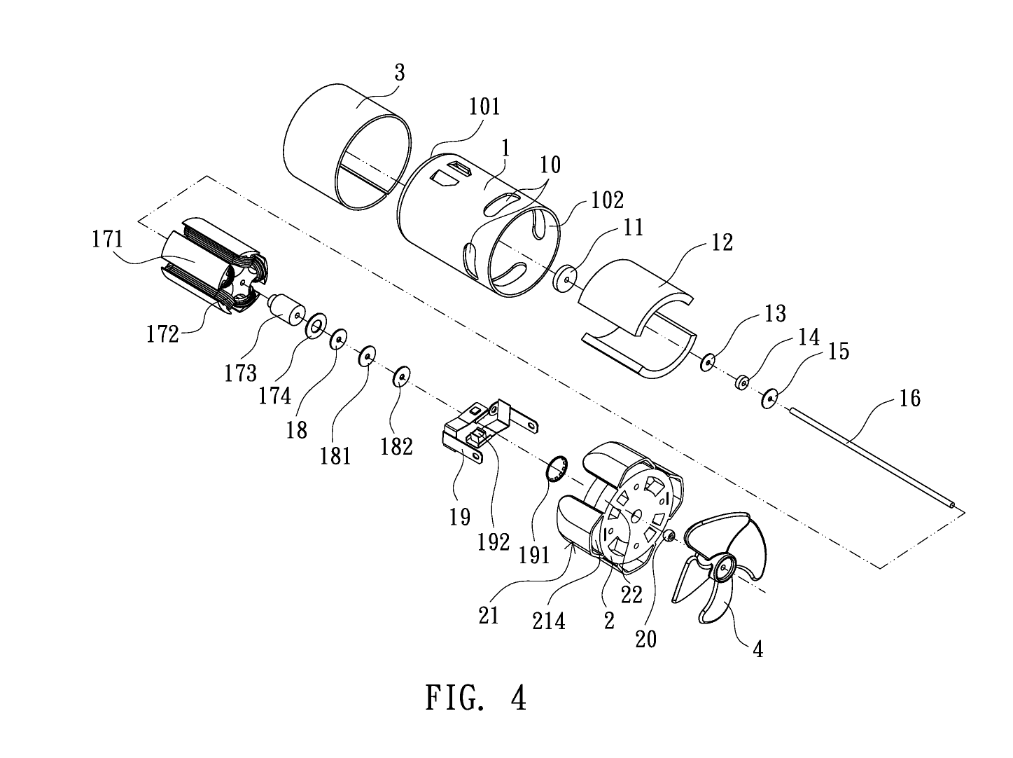

Since motors are commonly used devices, the principles of a motor's operation are not illustrated in the following paragraphs. However, basic elements of a motor will be described in this specification. Referring to FIGS. 1, 2 and 4, a motor according to one embodiment of the present invention is shown, which generally comprises a substantially cylindrical housing 1, a rotor assembly, a cover 2, and a cooling fan 4. The housing 1 has a circumferential wall which terminates at a flat closure wall 101 (a front end of the motor) and opens out at an opening 102 (a rear end of the motor) which is opposite to the flat closure wall 101 (see FIG. 4). The flat closure wall 101 is provided with a first bearing 11 at its center and defines a plurality of downstream through holes 103 around the first bearing 11 (see FIG. 2). The circumferential wall of the housing 1 defines a plurality of upstream through holes 10 (see FIG. 4).

The housing 1 is provided with a pair of opposite magnets 12 at the inner surface of its circumferential wall. In the housing 1, a rotor assembly is provided, which includes a number of washers 13, 181, 182, a thrust ring 14, an adjustment ring 15, a rotating shaft 16, an armature core formed by an iron core 171 wound with enameled wire 172, a commutator 173, a varistor 174, an oil-resistant ring 18, an electrical terminal unit 19, a compression ring 191, and a brush unit 192. A first end of the rotating shaft 16 of the rotor assembly is mounted to the first bearing 11 at the flat closure wall 101 of the housing 1.

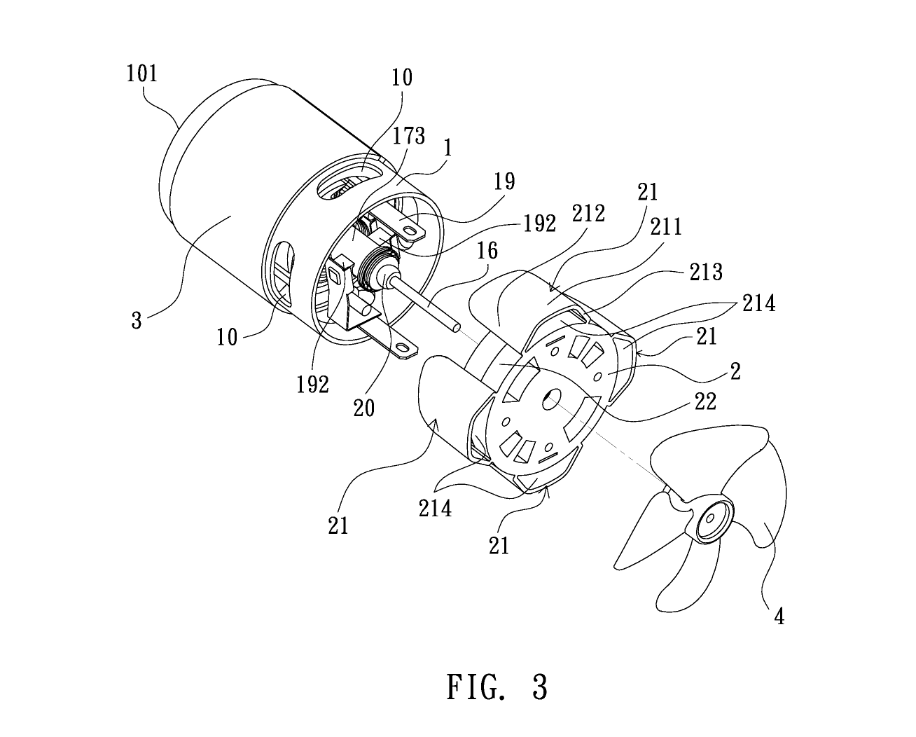

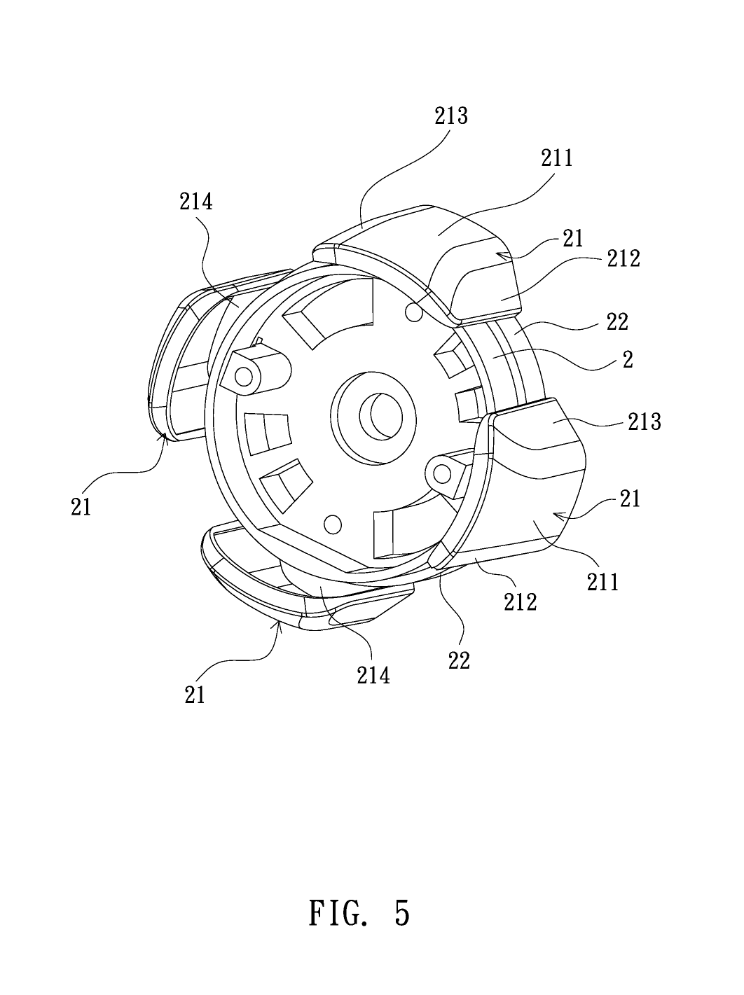

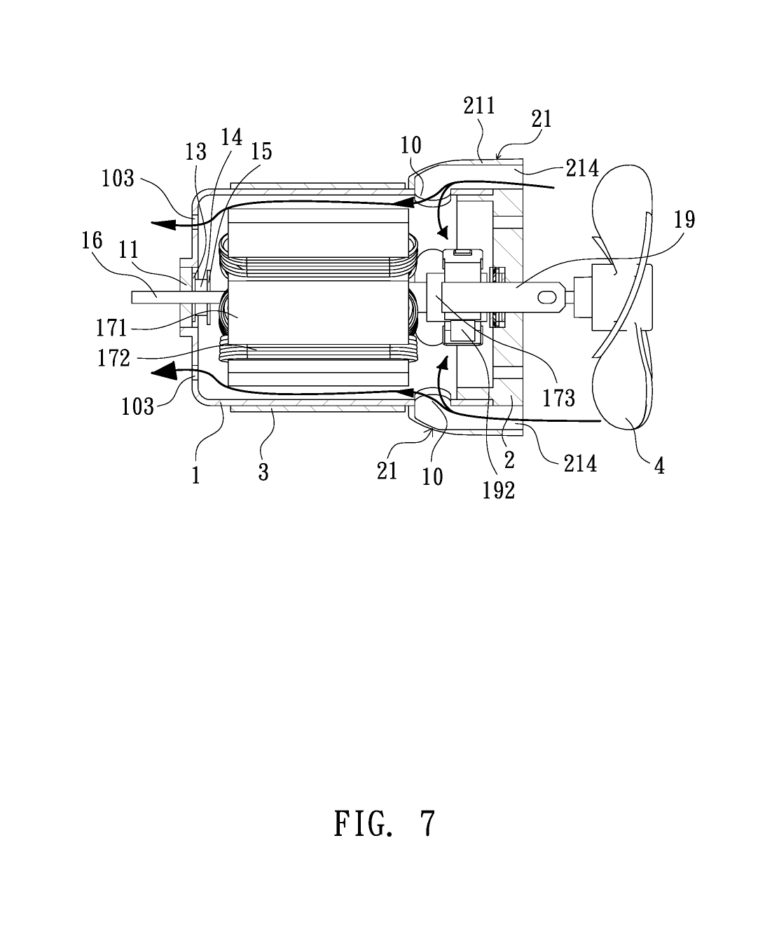

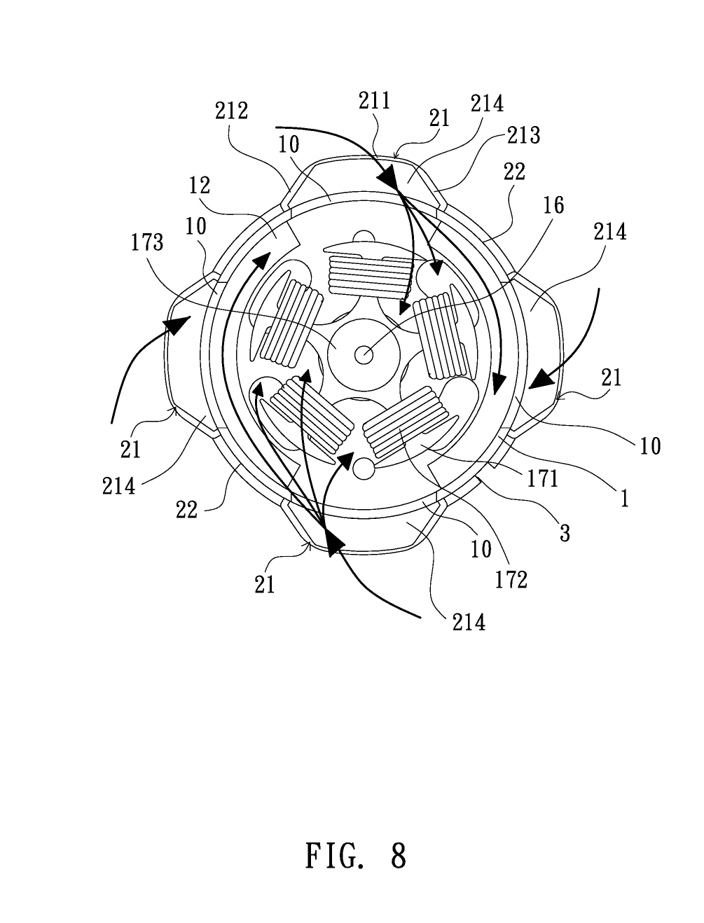

Referring to FIGS. 3 and 5, the cover 2 is provided with a second bearing 20 at its center and mounted to the housing 1 for sealing the opening 102 of the housing 1. A second end of the rotating shaft 16 of the rotor assembly is mounted at the second bearing 20 and installed with the cooling fan 4, which is located near the cover 2. As shown, the cover 2 is provided with a plurality of wind-catching projections 21 around its circumference, such that, when the cover 2 is mounted to the housing 1, each wind projection 21 is located above one of the upstream through holes 10 of the housing 1. Each of the wind-catching projections 21 is a bulging layer which has a roof 211 and two slant walls 212, 213 joined between the roof 211 and the circumference of the cover 2, such that an air guiding channel 214 is defined between the roof 211, the two slant walls 212, 213, and the circumference of the cover 2, wherein the air guiding channel 214 faces towards the cooling fan 4 and communicates with one of the upstream through holes 10. Furthermore, a recess 22 is defined between two adjacent wind catching projections 21. As such, the airflow induced by the cooling fan 4 can easily pass through the air guiding channels 214 and the upstream through holes 10 to enter the housing 1, so that the heat generated by the brush unit 192 and the commutator 173 due to friction therebetween, the heat generated by the enameled wire 172 due to electrical current, and the heat generated by the magnets 12 can be dissipated properly (see FIGS. 7 and 8).

Referring to FIG. 1, as described above, the cooling fan 4 is installed at the second end of the rotating shaft 16 of the rotor assembly, near the cover 2.

Referring to FIGS. 4 and 7, a sleeve 3, made of a magnetically permeable metal, can be closely fitted around the circumferential wall of the housing 1 to further increase the performance of the motor.

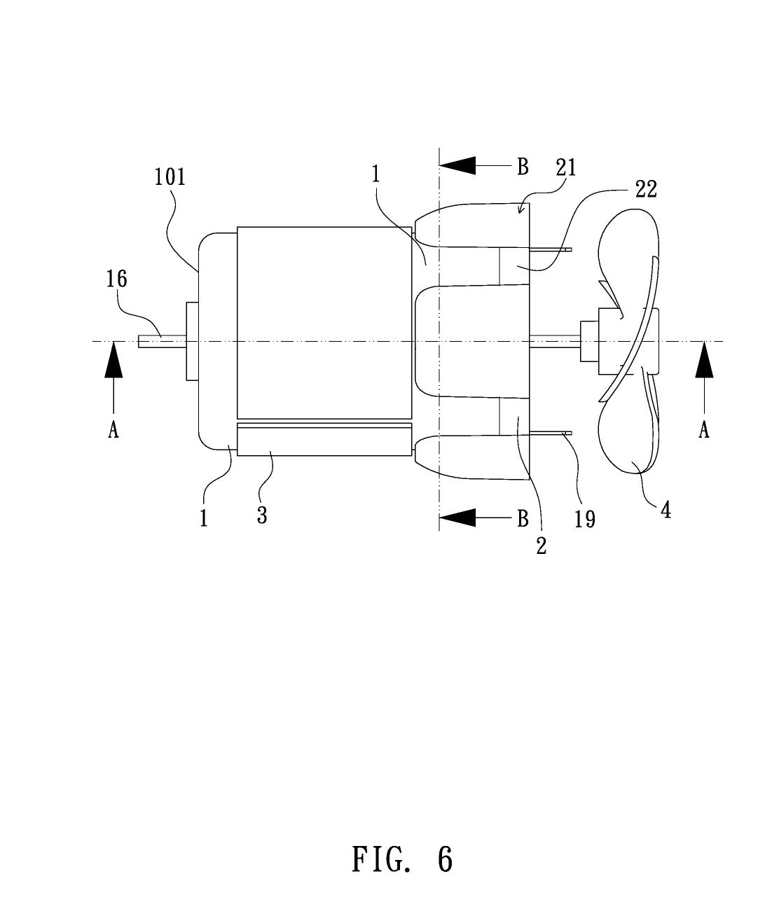

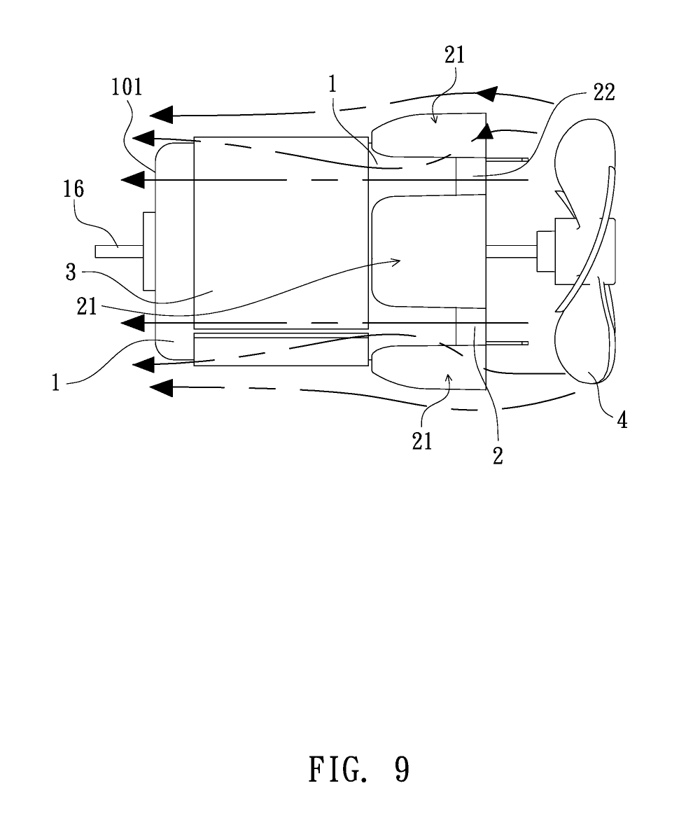

When the motor is running, as shown in FIGS. 6 through 9, the cooling fan 4 is rotated to induce airflow, which can pass through the air guiding channels 214 and the upstream through holes 10 to enter the housing 1, wherein the air guiding channels 214, which faces towards the cooling fan 4, can effectively collect most part of the airflow induced by the cooling fan 4 to enter the housing 1 and finally to go out of the housing 1 via the downstream through holes 103, so that the heat generated by the rotor assembly in the motor can be quickly dissipated. Particularly, the heat generated by the brush unit 192 and the commutator 173 (see FIG. 7), and the heat generated by the iron core 171 and the enameled wire 172 (see FIGS. 7 and 8) can be dissipated properly, so that heat is not easy to accumulate in the motor's housing. On the other hand, some of the airflow induced by the cooling fan 4, which does not enter the housing 1, can flow along the outer surface of the circumferential wall of the housing via the recesses 22 between the wind-catching projections 21 to cool down the housing 1 (see FIG. 9), so that the motor can be further protected from being damaged due to heat and thus the service life of the motor can be increased.

As a summary, the present invention is featured in that the cover 2 is provided with a plurality of wind-catching projections 21, each of which has one roof 211 and two slant walls 212, 213 joined between the roof 211 and the circumference of the cover 2 so as to define therebetween an air guiding channel 214 which faces towards the cooling fan 4 and communicates with one of the upstream through holes 10 of the motor's housing 1. Therefore, when the motor is running, the cooling fan 4 is rotated to induce airflow, which can easily pass through the air guiding channels 214 and the upstream through holes 10 to enter the motor's housing 1, and can finally go out of the housing 1 by way of the downstream through holes 103 to quickly take away the heat generated by the rotor assembly in the motor, so that heat is not easy to accumulate in the motor's housing 1. Therefore, the performance and service life of the motor can be increased.

I claim:

1. In a motor including a substantially cylindrical housing, a rotor assembly, a cover, and a cooling fan, the housing having a circumferential wall which terminates at a flat closure wall and opens out at an opening opposite to the flat closure wall, the flat closure wall of the housing being provided with a first bearing at its center and defining a plurality of downstream through holes, the circumferential wall of the housing defining a plurality of upstream through holes, the rotor assembly being located in the housing, the cover being provided with a second bearing at its center and mounted to the housing for sealing the opening of the housing, the cooling fan being mounted at one end of a rotating shaft of the rotor assembly, near the cover; wherein the improvement comprises:
the cover is provided with a plurality of wind-catching projections around its circumference, such that each wind-collecting projection is located above one of the upstream through holes of the housing, wherein each wind-catching projection defines an air guiding channel facing towards the cooling fan and communicating with one of the upstream through holes of the housing, so that the airflow induced by the cooling fan can easily pass through the air guiding channels and the upstream through holes to enter the housing, and can go out of the housing via the downstream through holes to take away the heat generated in the motor, so that heat is not easy to accumulate in the motor, thereby increasing the performance and service life of the motor.

2. The motor of claim 1, wherein each of the wind-catching projections is a bulging layer which has a roof and two slant walls joined between the roof and the circumference of the cover, the air guiding channel of each wind-catching projection being defined between the roof and the two slant walls of each wind-catching projection, and the circumference of the cover; whereby the airflow induced by the cooling fan can easily pass through the air guiding channels and the upstream through holes to enter the housing.

3. The motor of claim 1, wherein a sleeve, made of a magnetically permeable metal, is closely fitted around the circumferential wall of the housing to further increase the performance of the motor.

4. The motor of claim 1, wherein a recess is defined between two adjacent ones of the wind-catching projections , so that some of the airflow induced by the cooling fan, which does not enter the housing, may flow along the outer surface of the circumferential wall of the housing to cool down the housing.
